(19) United States
(12) Patent Application Publication
(10) Pub. No.: US 2025/0225667 A1
(43) Pub. Date: Jul. 10, 2025

(54) IMAGE ALIGNMENT FOR MULTI-FRAME FUSION OF TETRA OR OTHER IMAGE DATA

(71) Applicant: Samsung Electronics Co., Ltd., Suwon-si (KR)

(72) Inventors: Joshua P. Ebenezer, Plano, TX (US); Haegeun Lee, Seoul (KR); Hamid Rahim Sheikh, Allen, TX (US)

(21) Appl. No.: 18/911,561

(22) Filed: Oct. 10, 2024

Related U.S. Application Data
(60) Provisional application No. 63/617,851, filed on Jan. 5, 2024.

(51) Int. Cl. G06T 7/33; G06T 3/18; G06T 3/4038; G06T 5/20; G06T 5/70; G06T 7/246

(52) U.S. Cl. CPC G06T 7/337; G06T 3/18; G06T 3/4038; G06T 5/20; G06T 5/70; G06T 7/248

(57) ABSTRACT

Non-Bayer color filter array (CFA) input images including reference and non-reference images each having a non-Bayer CFA pattern are obtained. Reference and non-reference luma images respectively corresponding to a reference Bayer-like pattern based on the reference image and a non-reference Bayer-like pattern based on the non-reference image are generated. A resolution of each luma image is approximately half a resolution of each input image. A smoothing operation is performed on the luma images to remove artifacts and generate filtered reference and non-reference luma images. Motion vectors based on the filtered luma images are identified, and the motion vectors and filtered luma images are upscaled to generate upscaled motion vectors and upscaled luma images. High-resolution refinement of the upscaled motion vectors is performed based on the upscaled luma images to generate a finalized motion vector, and the input images are aligned with one another based on the finalized motion vector.

### CROSS-REFERENCE TO RELATED APPLICATION AND PRIORITY CLAIM

This application claims priority under 35 U.S.C. § 119(e) to U.S. Provisional Patent Application No. 63/617,851 filed on Jan. 5, 2024, which is hereby incorporated by reference in its entirety.

### TECHNICAL FIELD

This disclosure relates generally to image processing. More specifically, this disclosure relates to image alignment for multi-frame fusion of Tetra or other image data.

### BACKGROUND

Image registration or image alignment refers to aligning multiple images/frames of color filter array (CFA) camera sensor data in the presence of camera motion or small object motion without introducing significant image distortion. Image registration is often a necessary or desirable component in an image processing pipeline, such as in a multi-frame blending algorithm to support high dynamic range (HDR) imaging or motion blur reduction. These and other algorithms can be used to fuse multiple images, such as images captured using different exposure/International Standards Organization (ISO) sensitivity settings.

### SUMMARY

This disclosure relates to image alignment for multi-frame fusion of Tetra or other image data.

In a first embodiment, a method includes obtaining non-Bayer color filter array (CFA) input images including a reference image and a non-reference image each having a non-Bayer CFA pattern. The method also includes generating a reference luma image, which corresponds to a reference Bayer-like pattern based on the reference image, and a non-reference luma image, which corresponds to a non-reference Bayer-like pattern based on the non-reference image. A resolution of each of the reference luma image and the non-reference luma image is approximately half a resolution of each of the non-Bayer CFA input images. The method further includes performing a smoothing operation on the reference luma image and the non-reference luma image to remove artifacts caused by the non-Bayer CFA pattern and to generate a filtered reference luma image and a filtered non-reference luma image. The method also includes identifying motion vectors based on the filtered luma images. The method further includes upscaling the motion vectors and the filtered luma images to generate upscaled motion vectors, an upscaled reference luma image, and an upscaled non-reference luma image. In addition, the method includes performing high-resolution refinement of the upscaled motion vectors based on the upscaled luma images to generate a finalized motion vector and aligning the non-Bayer CFA input images with one another based on the finalized motion vector.

In a second embodiment, an electronic device includes at least one processing device configured to obtain non-Bayer CFA input images including a reference image and a non-reference image each having a non-Bayer CFA pattern. The at least one processing device is also configured to generate a reference luma image, which corresponds to a reference Bayer-like pattern based on the reference image, and a non-reference luma image, which corresponds to a non-reference Bayer-like pattern based on the non-reference image. A resolution of each of the reference luma image and the non-reference luma image is approximately half a resolution of each of the non-Bayer CFA input images. The at least one processing device is further configured to perform a smoothing operation on the reference luma image and the non-reference luma image to remove artifacts caused by the non-Bayer CFA pattern and generate a filtered reference luma image and a filtered non-reference luma image. The at least one processing device is also configured to identify motion vectors based on the filtered luma images. The at least one processing device is further configured to upscale the motion vectors and the filtered luma images to generate upscaled motion vectors, an upscaled reference luma image, and an upscaled non-reference luma image. In addition, the at least one processing device is configured to perform high-resolution refinement of the upscaled motion vectors based on the upscaled luma images to generate a finalized motion vector and align the non-Bayer CFA input images with one another based on the finalized motion vector.

In a third embodiment, a non-transitory machine readable medium contains instructions that when executed cause at least one processor of an electronic device to obtain non-Bayer CFA input images including a reference image and a non-reference image each having a non-Bayer CFA pattern. The instructions when executed also cause the at least one processor to generate a reference luma image, which corresponds to a reference Bayer-like pattern based on the reference image, and a non-reference luma image, which corresponds to a non-reference Bayer-like pattern based on the non-reference image. A resolution of each of the reference luma image and the non-reference luma image is approximately half a resolution of each of the non-Bayer CFA input images. The instructions when executed further cause the at least one processor to perform a smoothing operation on the reference luma image and the non-reference luma image to remove artifacts caused by the non-Bayer CFA pattern and generate a filtered reference luma image and a filtered non-reference luma image. The instructions when executed also cause the at least one processor to identify motion vectors based on the filtered luma images. The instructions when executed further cause the at least one processor to upscale the motion vectors and the filtered luma images to generate upscaled motion vectors, an upscaled reference luma image, and an upscaled non-reference luma image. In addition, the instructions when executed cause the at least one processor to perform high-resolution refinement of the upscaled motion vectors based on the upscaled luma images to generate a finalized motion vector and align the non-Bayer CFA input images with one another based on the finalized motion vector.

Any single one or any combination of the following features may be used with the first, second, or third embodiment. The smoothing operation may include a bicubic filtering operation. The motion vectors may be identified by comparing the filtered reference luma image and the filtered non-reference luma image to generate initial motion vectors with coarse-to-fine alignment, regularizing the initial motion vectors with a median filter to generate regularized motion vectors, and performing local alignment of the regularized motion vectors based on structure-guided mesh warping (SGMW) to generate the motion vectors. The high-resolution refinement may be performed by warping the upscaled non-reference luma image based on the upscaled motion vectors to generate a warped upscaled non-reference luma image, performing a block search for each pixel of the warped upscaled non-reference luma image based on a comparison of the warped upscaled non-reference luma image and the upscaled reference luma image, and refining the upscaled motion vectors based on the block search. Each of the non-Bayer CFA input images may be remosaiced to generate the reference Bayer-like pattern and the non-reference Bayer-like pattern, and a resolution of each of the reference Bayer-like pattern and the non-reference Bayer-like pattern may equal the resolution of each of the reference non-Bayer CFA input image and the non-reference non-Bayer CFA input image. The non-Bayer CFA pattern may include a Tetra CFA pattern. Each of the reference non-Bayer CFA input image and the non-reference non-Bayer CFA input image may be remosaiced by, for each of the reference non-Bayer CFA input image and the non-reference non-Bayer CFA input image, swapping pixels within a central region of the Tetra CFA pattern to form a plurality of Bayer CFA patterns. The reference luma image and the non-reference luma image may be generated by identifying luma based on pixels read from a central region of the non-Bayer CFA pattern in a Bayer-like CFA pattern.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration that may be employed for alignment of multi-frame non-Bayer data in accordance with this disclosure;

FIG. 2 illustrates an example process of aligning multi-frame non-Bayer data in accordance with this disclosure;

FIG. 3 illustrates an example pipeline for alignment of multi-frame Tetra data in accordance with this disclosure;

FIG. 4 illustrates an example image alignment for alignment of multi-frame Tetra data within the example pipeline of FIG. 3 in accordance with this disclosure;

FIGS. 5A through 5E illustrate an example remosaicing during image alignment of multi-frame Tetra data in accordance with this disclosure;

FIG. 6 illustrates an example array of luma values derived after remosaicing as explained in connection with FIGS. 5A through 5E in accordance with this disclosure;

FIGS. 7A and 7B illustrate an example luma image with a smoothing operation applied and the same luma image without smoothing in accordance with this disclosure;

FIGS. 8A through 8C illustrate an example generation of motion vectors with coarse-to-fine alignment in accordance with this disclosure;

FIGS. 9A and 9B illustrate an example effect of median filter regularization in accordance with this disclosure;

FIGS. 10A and 10B illustrate example variables for a process of structure-guided mesh warping in accordance with this disclosure;

FIGS. 11A and 11B and FIGS. 12A and 12B illustrate example effects of structure-preserving refinement during warping in accordance with this disclosure;

FIG. 13 and FIG. 14 illustrate example remosaicing and luma calculation applied to a hexa pattern CFA in accordance with this disclosure;

FIGS. 15A and 15B illustrate example effects on HDR contrast achieved by improved alignment in accordance with this disclosure;

FIGS. 16A and 16B illustrate example effects on edge sharpness achieved by improved alignment in accordance with this disclosure; and

FIGS. 17A and 17B illustrate example effects on blur achieved by improved alignment in accordance with this disclosure.

### DETAILED DESCRIPTION

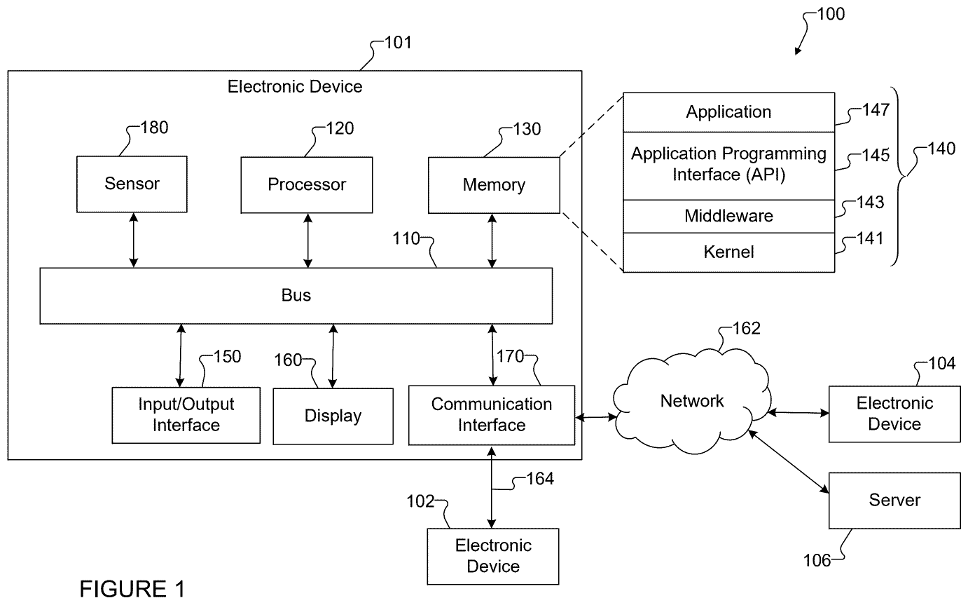

FIGS. 1 through 17B, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, image registration or image alignment refers to aligning multiple images/frames of color filter array (CFA) camera sensor data in the presence of camera motion or small object motion without introducing significant image distortion. Image registration is often a necessary or desirable component in an image processing pipeline, such as in a multi-frame blending algorithm to support high dynamic range (HDR) imaging or motion blur reduction. These and other algorithms can be used to fuse multiple images, such as images captured using different exposure/International Standards Organization (ISO) sensitivity settings.

Aligning Tetra CFAs can be a useful or important step in multi-frame fusion of Tetra camera data. If this alignment has low quality, the result can directly affect a subsequent image blending operation and may lead to insufficient blending level or even ghost artifacts. Tetra CFAs have a repeating pattern of four pixels of each color, which is different from pixel patterns in conventional Bayer CFAs. Algorithms designed for registration of Bayer CFAs can be applied directly to Tetra CFAs by first converting the Tetra CFAs to a Bayer pattern by binning every four pixels, but this process is not optimal and leads to a reduction of the image data resolution.

As the smartphone camera industry trends towards high megapixel cameras, such as 200 megapixels (MP) or more, image sensors are now adopting more novel color filter array patterns, such as Quad Bayer (Tetra), Nona, and Hexa Deca (Tetra2) patterns. Quad Bayer sensors (also referred to as Tetra sensors in this disclosure) are gaining in popularity. Tetra sensors offer the flexibility of extremely high-resolution captures (such as compared to Bayer sensors or other types of sensors) while also allowing the flexibility of binning adjacent pixels consisting of the same color channel for better imaging signals in low-light or short-exposure scenarios, which can increase signal-to-noise ratio by trading resolution. Given the very high resolutions in Tetra sensors, the captured data can be noisier as compared to typical 12MP Bayer sensors due to small pixel sizes.

The Tetra kernel pattern typically takes the form of a 4×4 pixel array. In a Tetra sensor, each 4×4 pixel array includes multiple 2×2 arrays. Each 2×2 array is clustered with the same color filter. For example, each 4×4 Tetra kernel pattern includes one 2×2 array having blue color filters, another 2×2 array having red color filters, and two other 2×2 arrays. Aligning Tetra CFAs can be a useful or important operation in multi-frame fusion of Tetra camera data. If this operation has low quality, various problems such as those described above may occur.

Tetra-to-Bayer conversion for Tetra color filter arrays, having a repeating pattern of four pixels of each color which is different from pixel patterns in conventional Bayer color filter arrays, may be employed. Current approaches designed for alignment of conventional Bayer color filter arrays can be applied directly to Tetra color filter arrays by first converting the Tetra pixel data to a Bayer pattern by binning every four pixels. In an example Tetra-to-Bayer pattern conversion, the four color pixels are simply averaged, producing a 2×2 array having one pixel corresponding to blue color filters, one pixel corresponding to red color filters, and two pixels and corresponding to green color filters. This approach of processing Tetra images is not optimal and leads to a reduction in the resolution of the data, such as from H×W (where H is the height and is the W width of the sensor array in pixels) to

$$\frac{H}{2} \times \frac{W}{2} .$$

The present disclosure employs remosaicing of the Tetra pattern or other pattern to convert the image into a Bayer color filter array pattern while reducing or avoiding loss of resolution. In some cases, a bicubic filter or other smoothing operation can be applied to remove color filter array artifacts. A registration algorithm can be applied on luma data, optionally with the use of a regularizing median filter on motion vectors. A final motion vector can be obtained, such as via upscaling and refinement at full-resolution to improve accuracy.

FIG. 1 illustrates an example network configuration 100 that may be employed for alignment of multi-frame non-Bayer data in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to image alignment for multi-frame fusion of Tetra or other image data.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to image alignment for multi-frame fusion of Tetra or other image data. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101. In some embodiments, the sensor(s) 180 include at least one camera or other imaging sensor that captures a burst of images, and the electronic device 101 can perform image alignment of two or more images within the captured burst as described in further detail below.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the server 106 may perform various operations related to image alignment for multi-frame fusion of Tetra or other non-Bayer image data.

Although FIG. 1 illustrates one example of a network configuration 100 including an electronic device 101 employed for alignment of multi-frame non-Bayer data, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

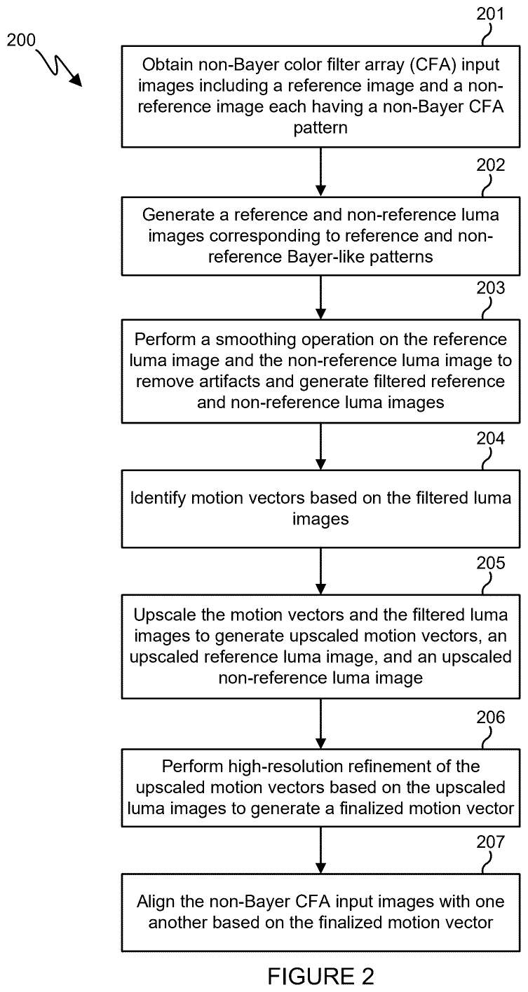

FIG. 2 illustrates an example process 200 of aligning multi-frame non-Bayer data in accordance with this disclosure. For ease of explanation, the process 200 of FIG. 2 is described as being performed using the electronic device 101 in the network configuration 100 of FIG. 1. However, the process 200 may be performed using any other suitable device(s) and in any other suitable system(s).

As shown in FIG. 2, the process 200 obtains non-Bayer CFA input images that include a reference image and a non-reference image (step 201). In some cases, the non-Bayer CFA input images may be Tetra images or hexa images. A reference luma image corresponding to a reference Bayer-like pattern is generated based on the reference image, and a non-reference luma image corresponding to a non-reference Bayer-like pattern is generated based on the non-reference image (step 202). For example, in some cases, remosaicing of the reference and non-reference images to the Bayer-like patterns may be performed. In other cases, pixel data may be read from the reference and non-reference images in a manner corresponding to the Bayer-like patterns. The resolution of each of the reference and non-reference luma images may be approximately half a resolution of each of the non-Bayer CFA input images.

A smoothing operation is performed on the reference and non-reference luma images, such as to remove artifacts caused by the non-Bayer CFA pattern, and filtered reference and non-reference luma images are generated (step 203). Motion vectors are identified based on the filtered luma images (step 204). For example, in some cases, the motion vectors may be identified by comparing the filtered reference and non-reference luma images to generate initial motion vectors with coarse-to-fine alignment, regularizing the initial motion vectors with a median filter, and performing local alignment of the regularized motion vectors based on structure-guided mesh warping.

The motion vectors and the filtered luma images are upscaled to generate upscaled motion vectors, an upscaled reference luma image, and an upscaled non-reference luma image (step 205). High-resolution refinement of the upscaled motion vectors is performed based on the upscaled luma images to generate a finalized motion vector (step 206). Example refinement may involve warping the upscaled non-reference luma image based on the upscaled motion vectors, performing a block search for each pixel in the resulting warped, upscaled non-reference luma image based on a comparison with the upscaled reference luma image, and refining the upscaled motion vectors based on the block search. The non-Bayer CFA input images are aligned with one another based on the finalized motion vector (step 207).

Although FIG. 2 illustrates one example of a process 200 of aligning multi-frame non-Bayer data, various changes may be made to FIG. 2. For example, while shown as a series of steps, various steps in FIG. 2 could overlap, occur in parallel, occur in a different order, or occur any number of times (including zero times).

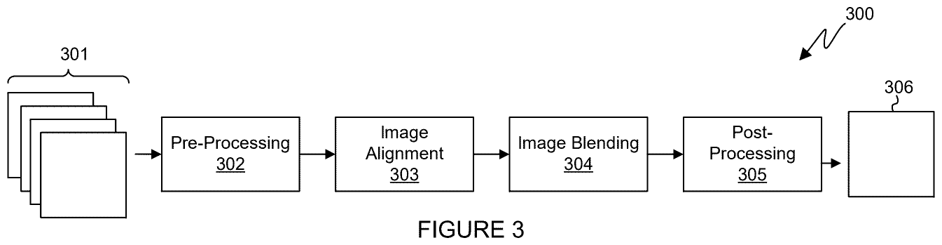

FIG. 3 illustrates an example pipeline 300 for alignment of multi-frame Tetra data in accordance with this disclosure. For ease of explanation, the pipeline 300 of FIG. 3 is described as being implemented or used by the electronic device 101 in the network configuration 100 of FIG. 1. However, the example pipeline 300 may be implemented or used by any other suitable device(s) and in any other suitable system(s).

As shown in FIG. 3, a burst of images 301 (such as those obtained during a multi-frame capture) are processed by a series of operations to yield a single image frame 306. In essence, the single image frame 306 is obtained by fusing the images 301 from the burst using the series of operations, which include pre-processing 302, image alignment 303, image blending 304, and post-processing 305. Examples of the pre-processing 302 may include white balance adjustment, black level adjustment, and lens shading correction. Both the input and the output of the pre-processing 302 may include multiple frames of image data.

The image alignment 303 involves selecting one frame from the burst of images 301 as the reference for alignment purposes. The selected frame may be the first frame of the burst, the middle frame of the burst, or any other frame of the burst (if, for example, a reference frame selection (RFS) algorithm is employed). Both the input and the output of the image alignment 303 may include multiple frames of image data. Image alignment 303 can align multiple images/frames of data in the Tetra color filter array format or other non-Bayer color filter array format in the presence of camera motion or object motion without introducing significant image distortion in an output single image frame 306. The image alignment 303 can therefore be used as a component in the pipeline 300 of any multi-frame blending process, such as high dynamic range (HDR) imaging, motion blur reduction, or other processes that fuse multiple images (possibly captured with different exposure/ISO sensitivity settings).

Image alignment under the present disclosure can remosaic the Tetra pattern or other non-Bayer pattern for conversion into a Bayer-like CFA without losing resolution. Following this, a smoothing filter (such as bicubic filter) can be applied, such as to remove CFA artifacts. A registration process can be applied on luma data, possibly with the use of a regularizing median filter on motion vectors. A final motion vector that is obtained may be upscaled and refined at full-resolution to improve accuracy. The present disclosure thus presents techniques for alignment of Tetra CFA or other CFA data with robustness provided by median filtering and higher accuracy provided by increased resolution. Specifics of the image alignment 303 are described in further detail below.

During the image blending 304, frames from the burst of images 301 (as aligned to the selected reference image) are averaged or otherwise blended in areas where there is little or no motion, while areas in which there is motion may be selected from the reference frame to avoid ghosting artifacts. The input of the image blending 304 may include multiple frames of image data, and the output of the image blending 304 may include a single frame. The post-processing 305 following the image blending 304 may include, for example, image enhancement, tone mapping, color correction, etc. Both the input and the output of the post-processing 305 may include a single image frame 306.

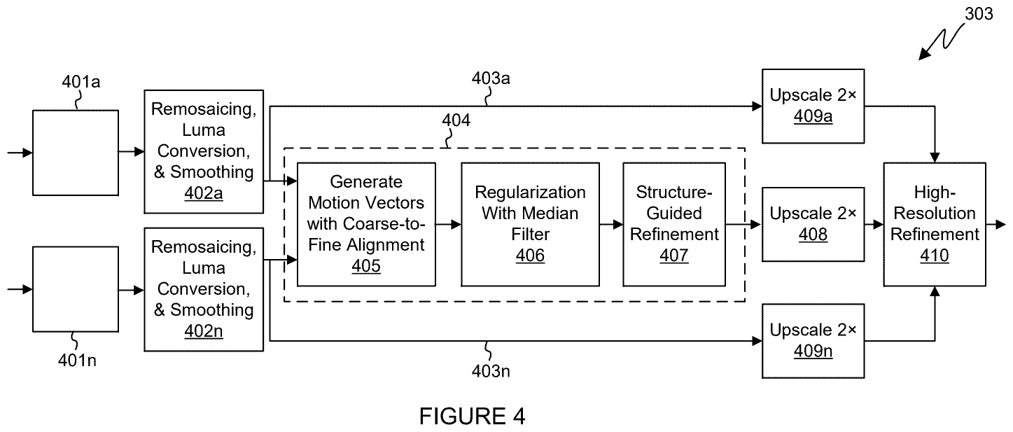

FIG. 4 illustrates an example image alignment 303 for alignment of multi-frame Tetra data within the example pipeline 300 of FIG. 3 in accordance with this disclosure. As shown in FIG. 4, the image alignment 303 receives a plurality of pre-processed image frames 401a-401n from the pre-processing 302, where each of the image frames 401a-401n corresponds to one of the images 301 after pre-processing of the type described above. Each of the image frames 401a-401n in the example of FIG. 4 has a Tetra CFA pattern at the same resolution (such as a 2H×2 W array, where H is the height of the array and W is the width of the array in numbers of pixels). The pipeline 300 remosaics the Tetra CFA pattern for conversion into a Bayer-like CFA pattern without losing resolution. Each of the image frames 401a-401n can be actually or effectively remosaiced and subjected to luma conversion and smoothing in blocks 402a-402n.

Although FIG. 3 illustrates one example pipeline 300 for alignment of multi-frame non-Bayer data and FIG. 4 illustrates one example of an architecture for image alignment 303 of multi-frame non-Bayer images, various changes may be made to FIGS. 3 and 4. For example, while the examples of FIGS. 3 and 4 are described in the context of Tetra image CFA patterns, the same pipeline 300 and architecture for image alignment 303 may be employed with other CFA patterns. For instance, the pipeline 300 and architecture for image alignment 303 may be implemented for a Hexa-Deca CFA pattern or a Nona CFA pattern.

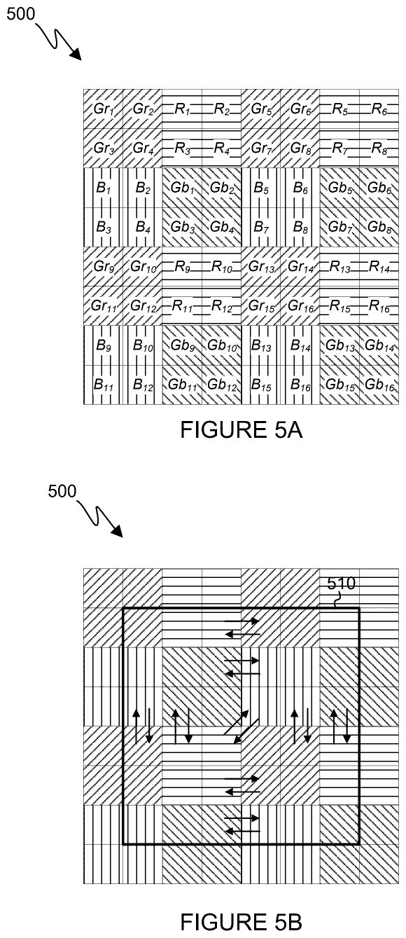

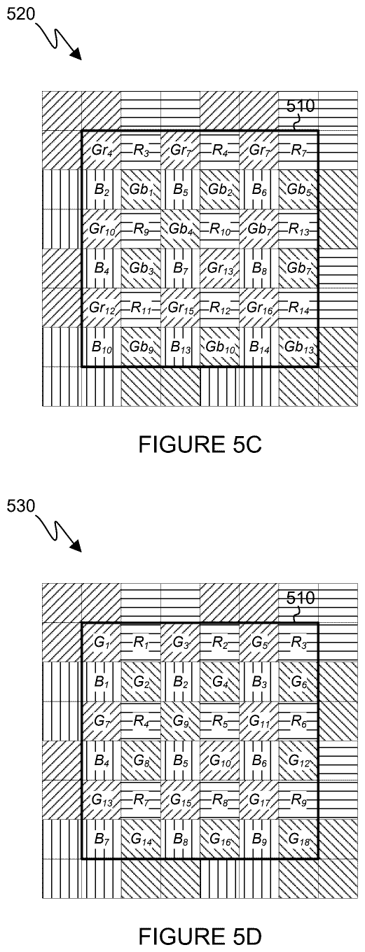

FIGS. 5A through 5E illustrate an example remosaicing during image alignment 303 of multi-frame Tetra data in accordance with this disclosure, and FIG. 6 illustrates an example array of luma values derived after remosaicing as explained in connection with FIGS. 5A through 5E in accordance with this disclosure. In some prior approaches, conventional Tetra-to-Bayer conversion is performed by binning every four pixels. In accordance with this disclosure, the Tetra data or other non-Bayer image data can be remosaiced.

FIG. 5A illustrates a labeled pixel arrangement 500 for a 16×16 array of Tetra CFA pattern image data, where each pixel can be uniquely labeled. During remosaicing, a central region 510 of the array shown in FIG. 5B is used. The central region 510 is the collection of pixels that do not reside on the first column, the last column, the first row, or the last row in the array for the Tetra CFA pattern image data. Pixels within the central region 510 can be remosaiced via pixel swapping as indicated by the arrows in FIG. 5B, producing the labeled pixel arrangement 520 shown in FIG. 5C (with pixels retaining the original pixel labels of FIG. 5A). As can be seen here, the resulting arrangement includes a set of Bayer-like CFA patterns in the central region 510. The pixels within the central region 510 of the array may be relabeled as shown in FIG. 5D, creating labeled pixel arrangement 540 for purposes of determining luma values.

A luma array 600 of luma values as shown in FIG. 6 can be calculated based on the labeled pixel arrangement 520 in FIG. 5D, such as by using the following equations:

$${Y}_{1} = f ( {R}_{1} , {G}_{1} , {G}_{2} , {B}_{1} )$$

$${Y}_{2} = f ( {R}_{2} , {G}_{3} , {G}_{4} , {B}_{2} )$$

$$⋮$$

$${Y}_{n} = f ( {R}_{n} , {G}_{2 n - 1} , {G}_{2 n} , {B}_{n} )$$

Here, n corresponds to an index for a Bayer-like CFA pattern within the labeled pixel arrangement 540 of FIG. 5D. Also, ƒ is a linear function, which could have the following form:

$$f ( {R}_{n} , {G}_{2 n - 1} , {G}_{2 n} , {B}_{n} ) = 0.2126 * {R}_{n} + 0.7152 * \frac{{G}_{2 n - 1} + {G}_{2 n}}{2} + 0.0722 * {B}_{n} .$$

The result of the remosaicing is an intermediate Bayer-like pattern that is used to compute a luma array for subsequent registration of different image frames 401a-401n. As can be seen here, the luma array 600 has about half the resolution (such as H×W) of the input Tetra CFA pattern image data. Further, it should be noted that the luma array 600 may be derived without actual creation of an intermediate Bayer-like array of the type illustrated in FIGS. 5C and 5D. In other approaches, for instance, the pixels of the Tetra image data can be read out in a modified sequence based on labeling of the pixels in the central region 510 with the labeled pixel arrangement 540 shown in FIG. 5E. By reading out pixel data in that fashion, the luma array 600 can be obtained without creation of the intermediate Bayer-like array using the same computations as given above.

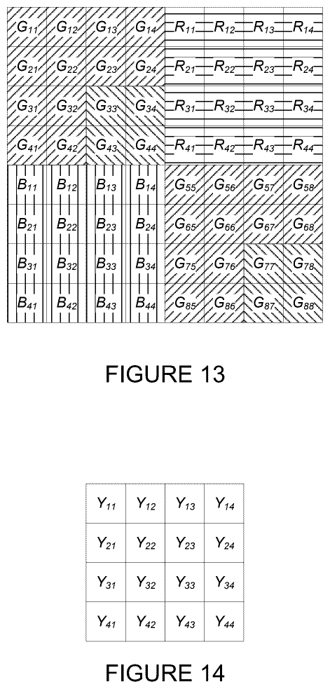

Although FIGS. 5A through 5E and FIG. 6 collectively illustrate one example of remosaicing and corresponding luma array creation during image alignment, various changes may be made to FIGS. 5A through 5E and FIG. 6. For example, while the examples of FIGS. 5A through 5E and FIG. 6 are described in the context of Tetra image CFA patterns, similar remosaicing and luma array creation may be implemented for a Hexa-Deca CFA pattern as described below in connection with FIGS. 13 and 14.

Referring back to FIG. 4, following computation of a luma array for each image frames 401a-401n, a smoothing filter (such as bicubic filter) can be applied to each luma array (such as to remove CFA artifacts), thereby producing smoothed luma arrays 403a-403n corresponding respectively to input Tetra image data 401a-401n. A smoothing filter (such as a bicubic filter or Gaussian filter) may be applied to both the Tetra and non-Tetra luma images, such as to smooth artifacts caused due to spatial offsets. In some cases, the general equation for such a smoothing filter may be expressed as follows.

$$p ( {Y}_{mn} ) = {\sum }_{i = m - {w}_{x}}^{m + {w}_{x}} {\sum }_{j = n - {w}_{y}}^{n + {w}_{y}} {a}_{ij} {Y}_{ij} ,$$

Here, Yₘₙ is the luma value at pixel location m, n and p(Yₘₙ) is the output of the smoothing filter, while aᵢⱼ are coefficients of the smoothing filter and wₓ, w_{y} are the kernel widths in the x and y directions. A specification example of such values may be expressed as follows.

$${w}_{x} = {w}_{y} = 1 , {a}_{ij} = \frac{1}{2 π} {e}^{= ( \frac{{( i - m )}^{2} + {( j - m )}^{2}}{2 {σ}^{2}} )} .$$

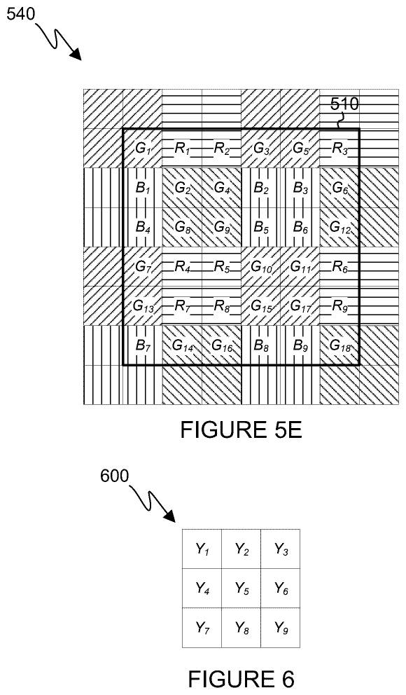

FIGS. 7A and 7B illustrate an example luma image with a smoothing operation applied and the same luma image without smoothing in accordance with this disclosure. As seen in the comparison, the smoothing operation reduces noisy artifacts in the circled region.

As noted above, one of the images 301 is selected as a reference. The corresponding image frame (such as the reference image frame 401a) may therefore be used to derive the reference luma array 403a, while the remainder (image frames other than the reference image frame 401a, including the non-reference image frame 401n) may each be used as a non-reference luma array 403n.

The luma arrays 403a-403n can be used by motion vector computation 404. For example, motion vectors with coarse-to-fine alignment may be generated in a block 405. As a particular example, the reference luma array 403a and the non-reference luma array 403n from the blocks 402a-402n may be compared to generate motion vectors with coarse-to-fine alignment (or, stated differently, in a coarse-to-fine search scheme for finding where each pixel in the reference luma array 403a has moved to in the non-reference luma array 403n). The motion vectors output by the block 405 can be regularized, such as with a median filter, in a block 406, the output of which can be subject to structure-guided mesh warping (SGMW) in a block 407 to perform local alignment for regions where features are found and global alignment where features are sparse. The output from the motion vector computation 404 (at the output of the block 407 in the example of FIG. 4) may include an M×N array of motion vectors.

The luma arrays 403a-403n can also be upscaled (such as to 2H×2 W) by blocks 409a-409n, and the motion vectors from the motion vector computation 404 can be similarly upscaled by a block 408 (such as to 2M×2N). In some cases, the upscaling may match the resolution of the non-Bayer CFA input. In a block 410, high resolution refinement of the motion vectors output by the motion vector computation 404 can be performed in the block 410, such as by using the upscaled motion vectors from the block 408 and the upscaled luma arrays from the blocks 409a-409n. In some cases, the high-resolution refinement may be performed using a block search, such as to remove small errors. The refined (and upscaled) motion vectors output by the block 410 may be employed by the image blending 304 in the pipeline 300.

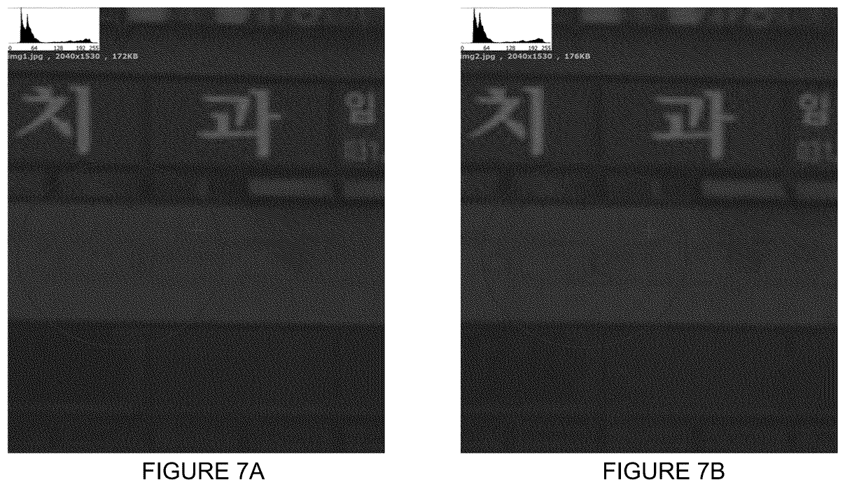

FIGS. 8A through 8C illustrate an example generation of motion vectors with coarse-to-fine alignment in accordance with this disclosure. This may, for example, be performed as part of the block 405 in FIG. 4. More specifically, FIG. 8A illustrates a reference image frame 801a (such as a specific image that may be used as the reference image frame 401a in FIG. 4), while FIG. 8B illustrates a non-reference image frame 801n (such as a counterpart image to the reference image frame 801a that may be used as the non-reference image frame 401n in FIG. 4).

In some embodiments, the approach illustrated in FIGS. 8A through 8C may be similar to that described in U.S. Pat. No. 11,151,731 (which is hereby incorporated by reference in its entirety). In the example of FIGS. 8A through 8C, coarse-to-fine alignment can be performed on four Gaussian pyramids of input frame regions 810a-810d. On each level, a search can be performed within the non-reference image frame 801n for a corresponding tile in a neighborhood of each tile in the reference image frame 801a, such as by using motion vectors estimated from the coarser scale as an initial guess. The tile size and search radius may vary with the different levels. Multiple hypotheses can be evaluated when up-sampling the coarser level of motion vectors to avoid boundary issues. For same-exposed images, the search for the nearest matching tile may minimize L2 norm distance in some cases. For different-exposed images, the search may maximize normalized cross-correlation in some cases. The search may generate pixel-level alignment, and a quadratic or other function may be used to fit near pixel minimums and directly compute subpixel minimums in order to generate subpixel-accurate motion vectors.

Although FIGS. 8A through 8C illustrate one example of motion vector generation during image alignment, various changes may be made to FIGS. 8A through 8C. For example, motion vectors on large moving objects need not be constrained during the search.

Referring back to FIG. 4, motion vectors can be generated in a coarse-to-fine scheme in the block 405 based on the reference luma array 403a and the non-reference luma array 403n, and the motion vectors can be regularized with a median filter in the block 406. Median filtering can be applied to the estimated motion vectors, such as by replacing the motion vector at each tile with the median value of the motion vectors in the neighborhood of the tile. This represents a form of regularization that helps to remove noisy motion estimates. One example of median filtering that can be performed on estimated motion vectors Mₓ(i,j), M_{y}(i,j) can be defined as follows, where Mₓ(i,j) is the value of the motion (estimated by the coarse-to-fine alignment) in the x direction at pixel location (i,j) and M_{y}(i,j) is the corresponding motion in the y direction at the same location. Given this, in some cases, the refined motion vectors Rₓ(i,j), R_{y}(i,j) may be expressed as follows.

$${R}_{x} ( i , j ) = median \{ {M}_{x} ( i , j ) \vert m , n are integers and i - {w}_{x} \leq m \leq i + {w}_{x} , j - {w}_{y} \leq n \leq j + {w}_{y} \}$$

$${R}_{y} ( i , j ) = median \{ {M}_{y} ( i , j ) \vert m , n are integers and i - {w}_{x} \leq m \leq i + {w}_{x} , j - {w}_{y} \leq n \leq j + {w}_{y} \}$$

Here, the median is defined as the value separating the higher half from the lower half of the set, and wₓ, w_{y} are the extents in the x and y directions over which the median of the motion vectors is computed. In a specific embodiment, wₓ=w_{y}=3.

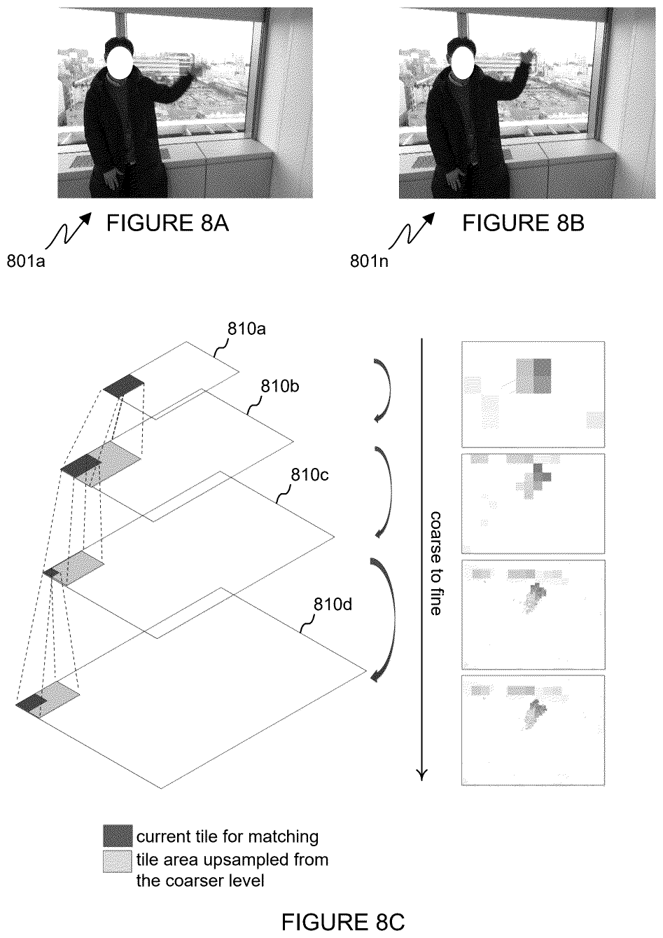

FIGS. 9A and 9B illustrate an example effect of median filter regularization in accordance with this disclosure. More specifically, FIG. 9A is a non-reference image warped using motion vectors computed from the coarse-to-fine alignment without the median filter regularization (based on the output of the block 405 without using the block 406). FIG. 9B is the same non-reference image warped after median filtering of the motion vectors used (using the output of the block 406). Comparison shows that median filtering preserves continuity of edges in the warped image.

Referring back to FIG. 4, the regularized motion vectors from the block 406 can be further refined by incorporating global and local information. For example, structure-guided mesh warping (SGMW) can be performed on the regularized motion vectors by the block 407 to perform local alignment for regions where features are found and global alignment where features are sparse.

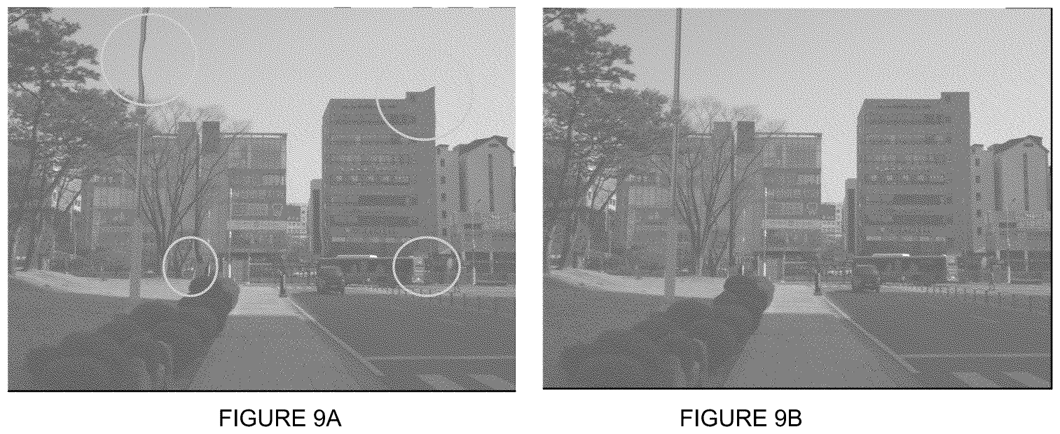

FIGS. 10A and 10B illustrate example variables for a process of structure-guided mesh warping in accordance with this disclosure. More specifically, FIG. 10A depicts a mesh before warping, where a feature point Pᵢ in a mesh unit (or “tile”) has vertices V₁, V₂, V₃, and V₄. Each mesh unit may be defined by dimensions u, v based on a triangle formed by mesh vertex coordinated Vₐ, V_{b}, and V_{c}. FIG. 10B depicts the same mesh after warping. With structure-preserving refinement, image structure can be preserved, such as by imposing quadratic constraints on the mesh vertex as follows:

$$E = {E}_{p} + {λ}_{1} {E}_{g} + {λ}_{2} {E}_{s} ,$$

Here, λ₁ and λ₂ are scaling factors. A local alignment term Eₚ indicates how the feature points (which may be represented by bilinear combination of vertices) in the non-reference frame may be warped to align with the corresponding feature points in the reference frame. The feature points in the reference frame may include centers of the tiles on the finest scale. The corresponding feature points in the non-reference frame may include the same feature points as in the reference frame but shifted by the computed motion vectors. A similarity term Eₛ indicates coordinates to represent a triangle (formed by three vertexes) that may be kept fixed after warping. A global constraint term E_{g} encourages “flat areas” and “large motion areas” to take a global affine transform. In some cases, the structure-guided mesh warping may be similar to that disclosed in U.S. Pat. No. 11,151,731.

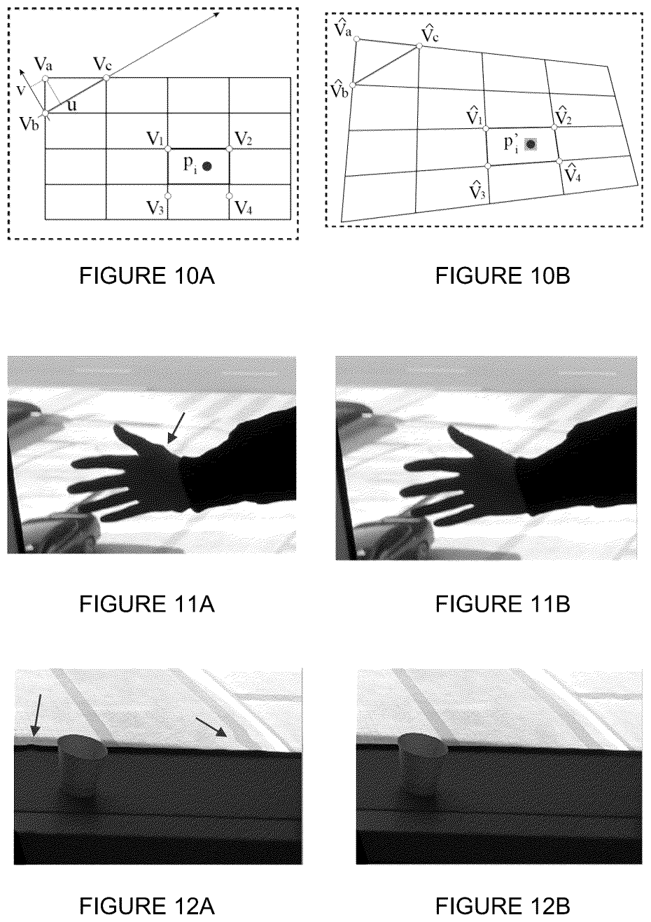

The result of the structure-guided refinement in the block 407 may include a motion vector whose resolution is M×N, where M and N do exceed the resolution of the input luma images (such as in this case H×W). FIGS. 11A and 11B and FIGS. 12A and 12B illustrate example effects of structure-preserving refinement during warping in accordance with this disclosure. More specifically, FIGS. 11A and 12A are images warped without structure-preserving refinement as described, while FIGS. 11B and 12B are counterparts warped with structure-preserving refinement.

Referring once again to FIG. 4, upscaling to match the resolution of the non-Bayer CFA can be performed on each of the following:
(a) the mesh obtained from the structure-guided mesh warping by the block 407 (in the block 408), yielding a 2M×2N motion vector;
(b) the reference luma image obtained from the block 402a (in the block 409a), yielding a 2H×2 W upscaled reference luma image; and
(c) the non-reference luma image obtained from the block 402n (in the block 409n), yielding a 2H×2 W upscaled non-reference luma image.

In some cases, the blocks 408, 409a, and 409n may perform bilinear upscaling in which linear interpolation is applied first in one direction to obtain interpolated values between adjacent pixel/motion vector locations and then in the orthogonal direction between adjacent locations to obtain luma images that are double the original resolution and motion vectors that are double the original resolution.

With the upscaled reference luma array from the block 409a, the upscaled motion vectors from the block 408, and the upscaled non-reference luma array from the block 409n, high-resolution refinement can be performed in the block 410, such as via a block search to remove small errors. Here, the upscaled non-reference luma image from the block 409n can be warped using the upscaled motion vectors from the block 408. In some cases, a block search can be performed for each pixel of the warped and upscaled non-reference image to refine the motion vectors. The resulting refined motion vectors are twice the resolution of the original motion vectors generated by motion vector computation 404.

In some embodiments, the block search may be performed in the same way as the coarse-to-fine alignment, but at a single scale as follows. A search for the corresponding tile in a neighborhood of the upscaled non-reference frame from the block 409n for each tile in the upscaled reference frame from the block 409a may be performed, such as by using the upscaled motion vectors estimated from the block 408 as an initial guess. The search can be performed by looking for the tile in the non-reference frame that minimizes the L2 norm with respect to the reference tile. The difference in the x, y directions between the location of the tile that minimizes the L2 norm from the location of the reference tile may be considered as the motion vector at that tile. The motion vector (2M×2N) that results can be used to align the 2H×2 W non-reference image frame 401n in the non-Bayer CFA images to the reference image frame 401a in the non-Bayer CFA images. In some embodiments, the alignment algorithm that may be used involves, for a tile at location (x,y) in the reference image, finding the tile in the non-reference image between locations (x−w, y−w) to (x+w, y+w) that minimizes the L2 norm between the non-reference tile and the reference tile. In particular embodiments, w=3.

FIGS. 5A through 5E and 6 illustrate remosaicing and luma calculation for a Tetra image input, where FIG. 5E and the associated description explain how Tetra image pixels can be read out in a modified sequence to effectively remosaic the input for purposes of luma computation. Remosaicing and luma calculation can be similarly applied to any generic non-Bayer RGB CFA to compute luma without losing resolution and without binning. FIG. 13 and FIG. 14 illustrate example remosaicing and luma calculation applied to a hexa pattern CFA in accordance with this disclosure. To obtain the luma array of FIG. 14 without creating an intermediate pixel pattern, the pixels of FIG. 13 can be read out in a modified sequence and used to calculate luma, such as in the following manner.

$${Y}_{11} = f ( {R}_{11} , {G}_{11} , {G}_{22} , {B}_{11} )$$

$${Y}_{12} = f ( {R}_{12} , {G}_{12} , {G}_{21} , {B}_{12} )$$

$$⋮$$

$${Y}_{31} = f ( {R}_{31} , {G}_{31} , {G}_{42} , {B}_{31} )$$

$$⋮$$

$${Y}_{mn} = f ( {R}_{mn} , {G}_{( 2 m - 1 ) ( 2 n - 1 )} , {G}_{( 2 m ) ( 2 n )} , {B}_{mn} ) .$$

Still other embodiments could use the following generalized equations.

$${Y}_{mn} = f ( {R}_{nm} , {G}_{( 2 m - 1 ) ( 2 n - 1 )} , {G}_{( 2 m ) ( 2 n )} , {B}_{nm} ) ,$$

$${Y}_{mn} = f ( {R}_{nm} , {G}_{( 2 m - 1 ) ( 2 n - 1 )} , {G}_{( 2 m - 1 ) ( 2 n )} , {B}_{nm} ) ,$$

$${Y}_{mn} = f ( {R}_{mn} , {G}_{( 2 m - 1 ) ( 2 n - 1 )} , {G}_{( 2 m - 1 ) ( 2 n )} , {B}_{mn} ) ,$$

$${Y}_{mn} = f ( {R}_{mn} , {G}_{( 2 m - 1 ) ( 2 n - 1 )} , {G}_{( 2 m ) ( 2 n - 1 )} , {B}_{mn} ) , or$$

$${Y}_{mn} = f ( {R}_{nm} , {G}_{( 2 m - 1 ) ( 2 n - 1 )} , {G}_{( 2 m ) ( 2 n - 1 )} , {B}_{nm} ) .$$

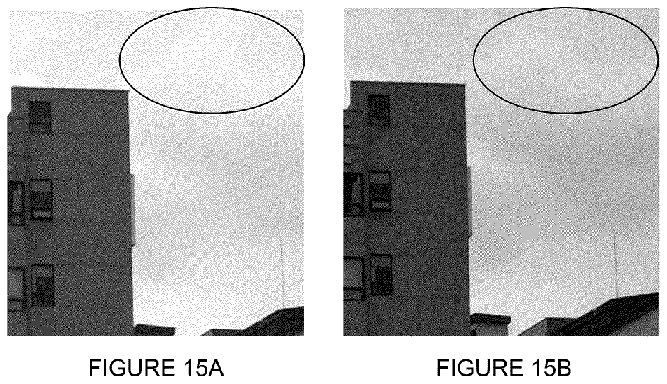

In the context of HDR applications, the techniques described above could use several input frames with different exposure times but the same ISO, meaning some of the input frames can be either over-exposed or under-exposed, in order to recover the high dynamic range of a scene. For example, FIGS. 15A and 15B illustrate example effects on HDR contrast achieved by improved alignment in accordance with this disclosure. Here, differences in HDR contrast without (FIG. 15A) and with (FIG. 15B) the improved alignment are shown, where contrast in the sky region allows cloud boundaries to be more clearly seen.

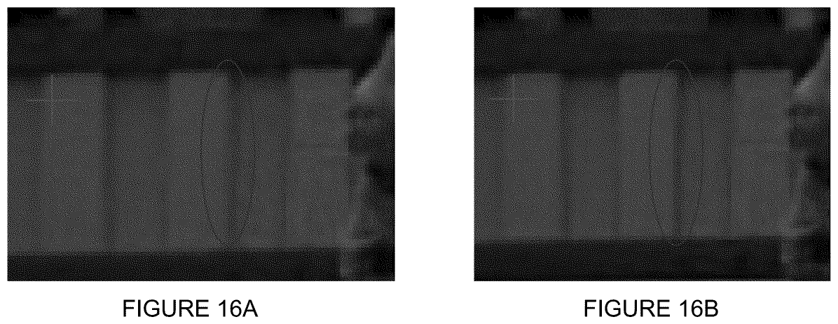

In the context of noise reduction applications, improved alignment allows accurate blending and fusion of frames to reduce noise and improve detail. FIGS. 16A and 16B illustrate example effects on edge sharpness achieved by improved alignment in accordance with this disclosure. Here, edges obtained without (FIG. 16A) and with (FIG. 16B) the improved alignment are shown.

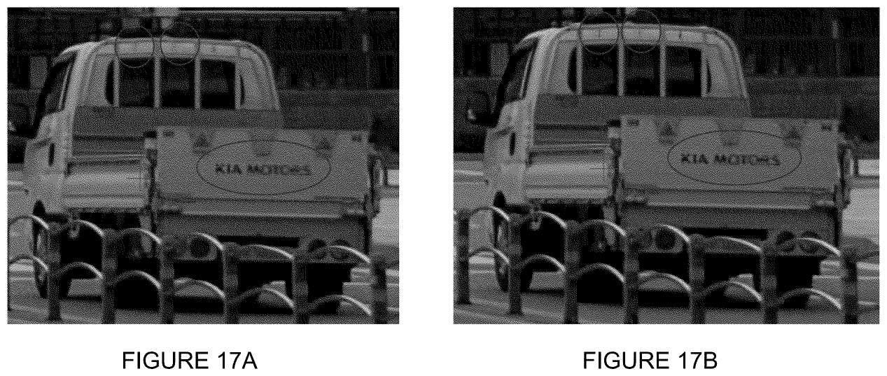

In the context of motion blur reduction involving several input frames of an object in motion, accurate registration aligns the object in motion across different frames and reduces blur caused due to the motion. FIGS. 17A and 17B illustrate example effects on blur achieved by improved alignment in accordance with this disclosure. Here, it can be seen that lines become less blurry and text gets clearer in the same image frames processed without (FIG. 17A) and with (FIG. 17B) the improved alignment.

Overall, in the context of multi-frame fusion, the techniques described above can improve HDR applications (where input frames are differently-exposed), motion blur reduction applications (where input frames have different noise levels), burst-denoising (where input frames may be equally exposed and have similar noise levels), panoramic views (where input frames are captured from different angles), and multi-camera fusion (where input frames are captured from different lenses). For multi-camera fusion, the techniques described above can be used to align input frames of Tetra data or other data from different lenses/sensors as long as there is sufficiently-large overlap in content.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, non-Bayer color filter array (CFA) input images comprising a reference non-Bayer CFA input image and a non-reference non-Bayer CFA input image each having a non-Bayer CFA pattern;
generating, using the at least one processing device, a reference luma image corresponding to a reference Bayer-like pattern based on the reference non-Bayer CFA input image and a non-reference luma image corresponding to a non-reference Bayer-like pattern based on the non-reference non-Bayer CFA input image, a resolution of each of the reference luma image and the non-reference luma image being approximately half a resolution of each of the reference non-Bayer CFA input image and the non-reference non-Bayer CFA input image;
performing, using the at least one processing device, a smoothing operation on the reference luma image and the non-reference luma image to remove artifacts caused by the non-Bayer CFA pattern and generate a filtered reference luma image and a filtered non-reference luma image;
identifying, using the at least one processing device, motion vectors based on the filtered reference luma image and the filtered non-reference luma image;
upscaling, using the at least one processing device, the motion vectors and the filtered reference luma image and the filtered non-reference luma image to generate upscaled motion vectors, an upscaled reference luma image, and an upscaled non-reference luma image;
performing, using the at least one processing device, high-resolution refinement of the upscaled motion vectors based on the upscaled, filtered reference luma image and the upscaled, filtered non-reference luma image to generate a finalized motion vector; and
aligning the reference non-Bayer CFA input image and the non-reference non-Bayer CFA input image with one another based on the finalized motion vector.

2. The method of claim 1, wherein the smoothing operation comprises a bicubic filtering operation.

3. The method of claim 1, wherein identifying the motion vectors comprises:
comparing the filtered reference luma image and the filtered non-reference luma image to generate initial motion vectors with coarse-to-fine alignment;
regularizing the initial motion vectors with a median filter to generate regularized motion vectors; and
performing local alignment of the regularized motion vectors based on structure-guided mesh warping (SGMW) to generate the motion vectors.

4. The method of claim 1, wherein performing the high-resolution refinement comprises:
warping the upscaled non-reference luma image based on the upscaled motion vectors to generate a warped upscaled non-reference luma image;
performing a block search for each pixel of the warped upscaled non-reference luma image based on a comparison of the warped upscaled non-reference luma image and the upscaled reference luma image; and
refining the upscaled motion vectors based on the block search.

5. The method of claim 1, further comprising:
remosaicing each of the non-Bayer CFA input images to generate the reference Bayer-like pattern and the non-reference Bayer-like pattern;
wherein a resolution of each of the reference Bayer-like pattern and the non-reference Bayer-like pattern equals the resolution of each of the reference non-Bayer CFA input image and the non-reference non-Bayer CFA input image.

6. The method of claim 5, wherein:
the non-Bayer CFA pattern comprises a Tetra CFA pattern; and
remosaicing each of the reference non-Bayer CFA input image and the non-reference non-Bayer CFA input image comprises, for each of the reference non-Bayer CFA input image and the non-reference non-Bayer CFA input image, swapping pixels within a central region of the Tetra CFA pattern to form a plurality of Bayer CFA patterns.

7. The method of claim 1, wherein generating the reference luma image and the non-reference luma image comprises:
identifying luma based on pixels read from a central region of the non-Bayer CFA pattern in a Bayer-like CFA pattern.

8. An electronic device comprising:
at least one processing device configured to:
obtain non-Bayer color filter array (CFA) input images comprising a reference non-Bayer CFA input image and a non-reference non-Bayer CFA input image each having a non-Bayer CFA pattern;
generate a reference luma image corresponding to a reference Bayer-like pattern based on the reference non-Bayer CFA input image and a non-reference luma image corresponding to a non-reference Bayer-like pattern based on the non-reference non-Bayer CFA input image, a resolution of each of the reference luma image and the non-reference luma image being approximately half a resolution of each of the reference non-Bayer CFA input image and the non-reference non-Bayer CFA input image;
perform a smoothing operation on the reference luma image and the non-reference luma image to remove artifacts caused by the non-Bayer CFA pattern and generate a filtered reference luma image and a filtered non-reference luma image;
identify motion vectors based on the filtered reference luma image and the filtered non-reference luma image;
upscale the motion vectors and the filtered reference luma image and the filtered non-reference luma image to generate upscaled motion vectors, an upscaled reference luma image, and an upscaled non-reference luma image;
perform high-resolution refinement of the upscaled motion vectors based on the upscaled, filtered reference luma image and the upscaled, filtered non-reference luma image to generate a finalized motion vector; and
align the reference non-Bayer CFA input image and the non-reference non-Bayer CFA input image with one another based on the finalized motion vector.

9. The electronic device of claim 8, wherein the smoothing operation comprises a bicubic filtering operation.

10. The electronic device of claim 8, wherein, to identify the motion vectors, the at least one processing device is configured to:
compare the filtered reference luma image and the filtered non-reference luma image to generate initial motion vectors with coarse-to-fine alignment;
regularize the initial motion vectors with a median filter to generate regularized motion vectors; and
perform local alignment of the regularized motion vectors based on structure-guided mesh warping (SGMW) to generate the motion vectors.

11. The electronic device of claim 8, wherein, to perform the high-resolution refinement, the at least one processing device is configured to:
warp the upscaled non-reference luma image based on the upscaled motion vectors to generate a warped upscaled non-reference luma image;
perform a block search for each pixel of the warped upscaled non-reference luma image based on a comparison of the warped upscaled non-reference luma image and the upscaled reference luma image; and
refine the upscaled motion vectors based on the block search.

12. The electronic device of claim 8, wherein:
the at least one processing device is further configured to remosaic each of the reference non-Bayer CFA input image and the non-reference non-Bayer CFA input image to generate the reference Bayer-like pattern and the non-reference Bayer-like pattern; and
a resolution of each of the reference Bayer-like pattern and the non-reference Bayer-like pattern equals the resolution of each of the reference non-Bayer CFA input image and the non-reference non-Bayer CFA input image.

13. The electronic device of claim 12, wherein:
the non-Bayer CFA pattern comprises a Tetra CFA pattern; and
to remosaic each of the reference non-Bayer CFA input image and the non-reference non-Bayer CFA input image, the at least one processing device is configured, for each of the reference non-Bayer CFA input image and the non-reference non-Bayer CFA input image, to swap pixels within a central region of the Tetra CFA pattern to form a plurality of Bayer CFA patterns.

14. The electronic device of claim 8, wherein, to generate the reference luma image and the non-reference luma image, the at least one processing device is configured to:
identify luma based on pixels read from a central region of the non-Bayer CFA pattern in a Bayer-like CFA pattern.

15. A non-transitory machine readable medium containing instructions that when executed cause at least one processor of an electronic device to:
obtain non-Bayer color filter array (CFA) input images comprising a reference non-Bayer CFA input image and a non-reference non-Bayer CFA input image each having a non-Bayer CFA pattern;
generate a reference luma image corresponding to a reference Bayer-like pattern based on the reference non-Bayer CFA input image and a non-reference luma image corresponding to a non-reference Bayer-like pattern based on the non-reference non-Bayer CFA input image, a resolution of each of the reference luma image and the non-reference luma image being approximately half a resolution of each of the reference non-Bayer CFA input image and the non-reference non-Bayer CFA input image;
perform a smoothing operation on the reference luma image and the non-reference luma image to remove artifacts caused by the non-Bayer CFA pattern and generate a filtered reference luma image and a filtered non-reference luma image;
identify motion vectors based on the filtered reference luma image and the filtered non-reference luma image;
upscale the motion vectors and the filtered reference luma image and the filtered non-reference luma image to generate upscaled motion vectors, an upscaled reference luma image, and an upscaled non-reference luma image;
perform high-resolution refinement of the upscaled motion vectors based on the upscaled, filtered reference luma image and the upscaled, filtered non-reference luma image to generate a finalized motion vector; and
align the reference non-Bayer CFA input image and the non-reference non-Bayer CFA input image with one another based on the finalized motion vector.

16. The non-transitory machine readable medium of claim 15, wherein the smoothing operation comprises a bicubic filtering operation.

17. The non-transitory machine readable medium of claim 15, wherein the instructions that when executed cause the at least one processor to identify the motion vectors comprise:
instructions that when executed cause the at least one processor to:
compare the filtered reference luma image and the filtered non-reference luma image to generate initial motion vectors with coarse-to-fine alignment;
regularize the initial motion vectors with a median filter to generate regularized motion vectors; and
perform local alignment of the regularized motion vectors based on structure-guided mesh warping (SGMW) to generate the motion vectors.

18. The non-transitory machine readable medium of claim 15, wherein the instructions that when executed cause the at least one processor to perform the high-resolution refinement comprise:
instructions that when executed cause the at least one processor to:
warp the upscaled non-reference luma image based on the upscaled motion vectors to generate a warped upscaled non-reference luma image;
perform a block search for each pixel of the warped upscaled non-reference luma image based on a comparison of the warped upscaled non-reference luma image and the upscaled reference luma image; and
refine the upscaled motion vectors based on the block search.

19. The non-transitory machine readable medium of claim 15, further containing instructions that when executed cause the at least one processor to remosaic each of the reference non-Bayer CFA input image and the non-reference non-Bayer CFA input image to generate the reference Bayer-like pattern and the non-reference Bayer-like pattern;
wherein a resolution of each of the reference Bayer-like pattern and the non-reference Bayer-like pattern equals the resolution of each of the reference non-Bayer CFA input image and the non-reference non-Bayer CFA input image.

20. The non-transitory machine readable medium of claim 15, wherein the instructions that when executed cause the at least one processor to generate the reference luma image and the non-reference luma image comprise:
instructions that when executed cause the at least one processor to identify luma based on pixels read from a central region of the non-Bayer CFA pattern in a Bayer-like CFA pattern.
